(19) United States
(12) Patent Application Publication
(10) Pub. No.: US 2011/0206930 A1
(43) Pub. Date: Aug. 25, 2011

(54) ULTRA SMOOTH SURFACE BICOMPOSITE FIBER SHEET AND PROCESS FOR PREPARING

(76) Inventors: Jill Wyse, West Unity, OH (US); Lynn Wyse, West Unity, OH (US); Chet Cromwell, Jerome, MI (US)

(21) Appl. No.: 13/034,403

(22) Filed: Feb. 24, 2011

Related U.S. Application Data
(60) Provisional application No. 61/307,594, filed on Feb. 24, 2010.

(51) Int. Cl. D02G 3/00; C09J 5/06

(52) U.S. Cl. 428/373; 428/375; 156/322

(57) ABSTRACT

A method of producing a sheet includes heating a bicomposite sheet to a temperature sufficient to melt one of the materials comprising the bicomposite sheet with the bicomposite sheet adjacent to an inert film.

### CROSS-REFERENCE TO RELATED APPLICATIONS

This application claims the benefit of United States Provisional Application No. 61/307,594, filed Feb. 24, 2010, the disclosure of which is incorporated herein by reference.

### BACKGROUND OF THE INVENTION

This invention relates in general to a smooth finish on sheet. The smooth finish provides a low coefficient of friction surface, making the sheet suitable for use as a protective or spacing material that allows objects to easily slide over it.

### SUMMARY OF THE INVENTION

This invention relates to a method of producing a sheet. The method comprises heating a bicomposite sheet to a temperature sufficient to melt one of the materials comprising the bicomposite sheet with the bicomposite sheet adjacent to an inert film.

This invention further relates to a sheet comprising a fiber material that is heated to a temperature sufficient to melt a portion the fiber material. The fiber material is placed in contact with an inert film so that at least one surface of the fiber material is able to take on the characteristics of the inert film.

Various aspects of this invention will become apparent to those skilled in the art from the following detailed description of the disclosed embodiments, when read in light of the accompanying drawings.

### BRIEF DESCRIPTION OF THE DRAWINGS

FIG. 1 is a schematic view of a web treatment process used to create a smooth surface bicomposite sheet.

FIG. 2 is a perspective view of a bicomponent fiber having a core/sheath configuration, suitable for use in making the fiber web used in the web treatment process illustrated in FIG. 1.

FIG. 3 is a perspective view of a bicomponent fiber having a side-by-side configuration, suitable for use in making the fiber web used in the web treatment process illustrated in FIG. 1.

FIG. 4 is a schematic view of a spunbonding process used to create bicomponent fibers suitable for use in the web treatment process.

FIG. 5 is a schematic view of a first alternative web treatment process used to create a smooth surface bicomposite sheet. The first alternative web treatment process uses two layers of web material and two films.

FIG. 6 is a schematic view of a second alternative web treatment process used to create a smooth surface bicomposite sheet. The second alternative web treatment process uses a film on the nip rollers.

FIG. 7 is a schematic view of a melt spinning process, suitable for creating bicomponent fibers suitable for use in the web treatment process.

FIG. 8 is a schematic view of a dry spinning process, suitable for creating bicomponent fibers suitable for use in the web treatment process.

FIG. 9 is a schematic view of a wet spinning process, suitable for creating bicomponent fibers suitable for use in the web treatment process.

FIG. 10 is a schematic view of a melt blowing process, suitable for creating bicomponent fibers suitable for use in the web treatment process.

FIG. 11 is a cross sectional view of a portion of the fiber web material.

FIG. 12 is a cross sectional view of a portion of the smooth surface bicomposite sheet.

### DETAILED DESCRIPTION OF THE PREFERRED EMBODIMENTS

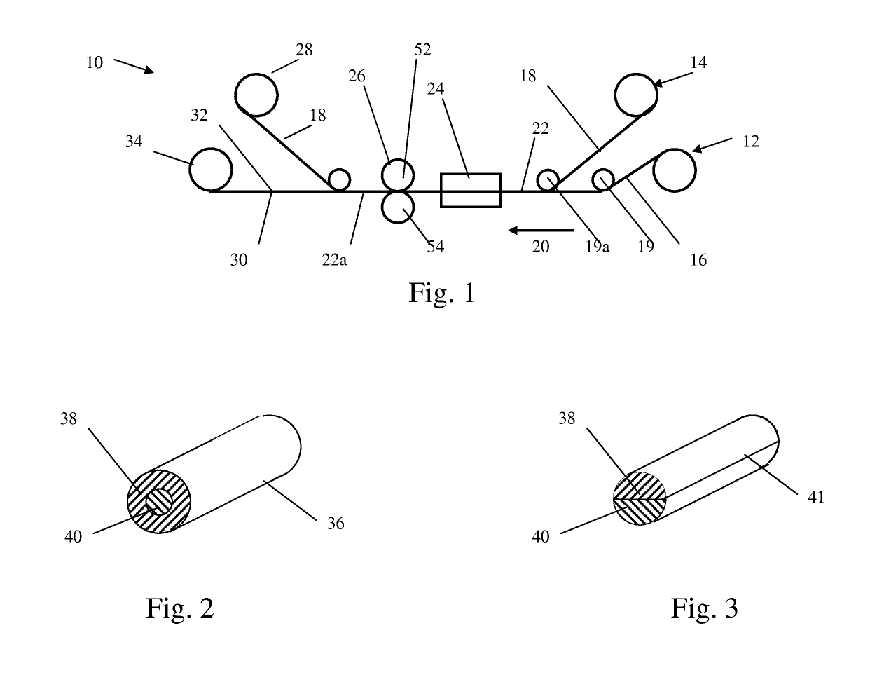

Referring now to the drawings, there is illustrated in FIG. 1 a schematic view of a web treatment process, indicated generally at 10, which is used to create a smooth surface bicomposite sheet. The web treatment process 10 will first be described in general, and then specific operating values and materials suitable for use with the web treatment process 10 will be described.

As shown in FIG. 1, a bicomposite fiber roll, indicated generally at 12, and an inert film roll, indicated generally at 14, are fed into the web treatment process 10. In the illustrated web treatment process 10, the fiber roll 12 is a nonwoven web material 16 and the inert roll 14 is an inert film 18. The illustrated inert film 18 is a high strength, temperature resistant film. In the illustrated web treatment process 10, the nonwoven web material 16 and the inert film 18 are fed in the direction indicated by the arrow 20 by the rollers 19 and 19a, respectively.

In the illustrated web treatment process 10, the nonwoven web material 16 is fed adjacent to and in contact with the inert film 14 to create a laminate sheet 22. The laminate sheet 22 is then passed through an optional pre-heater 24. The pre-heater 24 can be an infrared heater, a hot air oven, or any other suitable heat source. The laminate sheet 22 is then passed through a heated compaction nip 26. In the heated compaction nip 26, the laminate sheet 22 is heated to a sufficient temperature to melt one of the materials comprising the nonwoven web material 16 or portions of the nonwoven web material 16, but not sufficient to melt another one of the materials comprising the nonwoven web material 16. The melted portions of the nonwoven web material 16 are able to flow and take on the characteristics of the adjacent inert film 18. It should be appreciated that the nonwoven web material 16 may be heated before it is placed in contact with the inert film 14, if desired.

Next in the web treatment process 10, the treated laminate sheet 22a is allowed to cool to a temperature which is below the melting point of the nonwoven web material 16. Following this, the inert film 18 is then removed from the treated laminate sheet 22a and is rewound on a finished inert roll 28. The finished inert roll 28 can be reused in the web treatment process 10. This leaves a finished web 30 with a finished surface 32. The finished surface 32 is very smooth, having the characteristics of the inert film 18. The finished web 30 is rewound on a finished nonwoven roll 34. It should be appreciated that it may not be necessary to allow the treated laminate sheet 22a to cool to a temperature which is below the melting point of the nonwoven web material before removing the inert film 18. Depending on the properties of the nonwoven web material 16 and the inert film 18 and the desired properties of finished web 30, for example, the inert film 18 may be removed before the treated laminate sheet 22a has cooled.

It should be appreciated that while the web treatment process 10 is described using a nonwoven web material 16, a woven material is suitable for use in the web treatment process 10. In the illustrated web treatment process 10, the nonwoven web material 16 is a spunbonded web consisting of bicomponent fibers, which are heat embossed for additional strength. The components of the bicomponent fibers have a core/sheath configuration, such as for example as shown in FIG. 2. The illustrated bicomponent fibers 36 are composed of polyester 38 over a polypropylene core 40. It should be appreciated that the bicomponent fibers could have a different configuration. For example, as shown in FIG. 3, bicomponent fibers 41 having a side-by-side configuration of polyester 38 and polypropylene 40 could be used. Those skilled in the art will recognize that there are many other bicomponent configurations in addition to the core/sheath and side-by-side examples illustrated. Further, the bicomponent fibers could have different component chemistries. For example, the bicomponent fibers could be polyethylene and polypropylene, or any other suitable fiber. The basis weight range of the illustrated web is 1 to 4 oz/yd².

Those skilled in the art will recognize that there are many more examples of bicomponent fibers which can be used, besides the polyester-polypropylene and polyethylene-polypropylene chemistries. The polyester-polypropylene and polyethylene-polypropylene chemistries are advantageous in that the two components have sufficiently different melting temperature such that with adequate and typical temperature application methods found in the industry, the temperature can be controlled readily so as to only melt the lower melting component of the fiber without affecting the higher melting component. It should also be understood that while the web treatment process 10 is described using a bicomposite fiber roll, the fiber roll may be comprised of more than two types of materials, if desired.

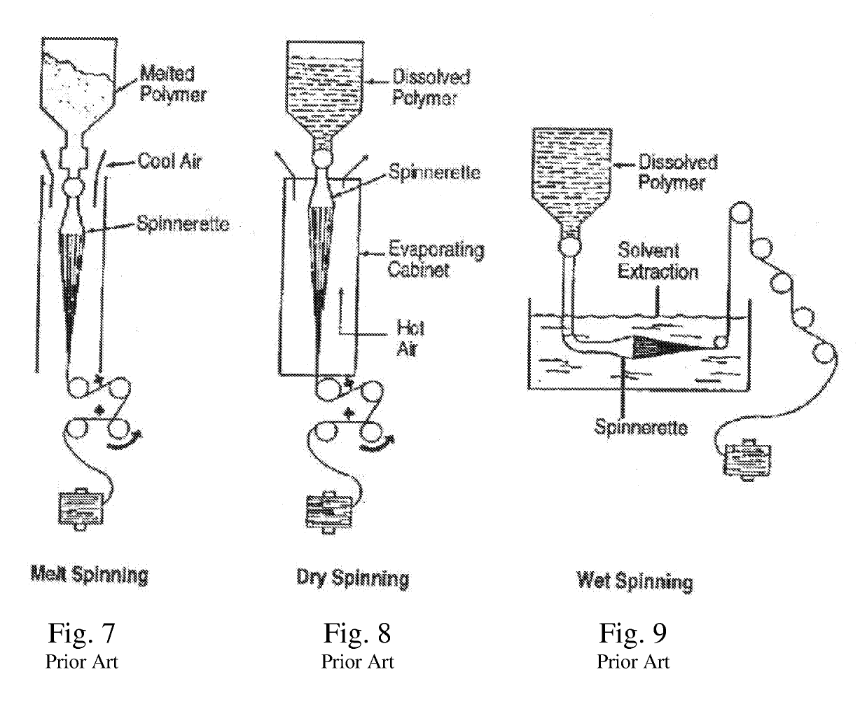

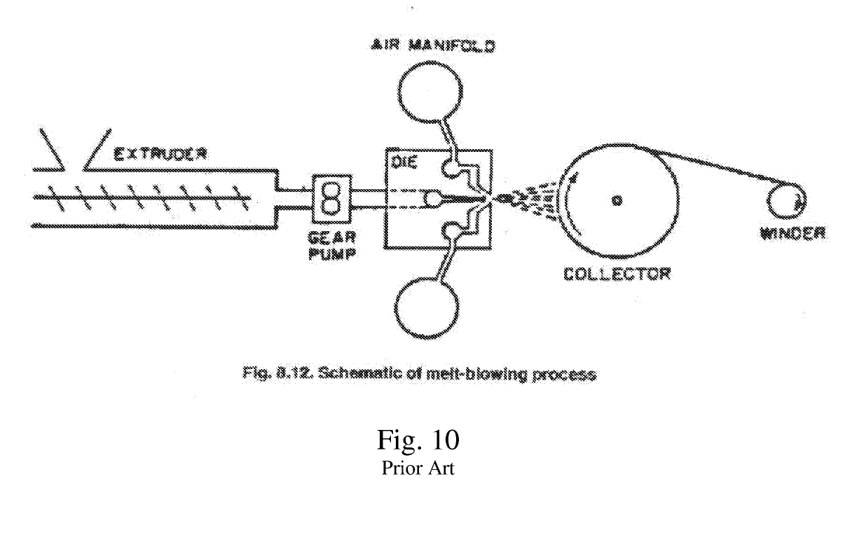

It should be understood that virtually any method for producing a fibrous web should produce suitable nonwoven web material 16 for use in the illustrated web treatment process 10. Suitable examples of non-woven fibrous web manufacturing technologies are known in the art and include such processes as melt spinning (shown in FIG. 7), dry spinning (shown in FIG. 8), wet spinning (shown in FIG. 9) and melt blow (shown in FIG. 10).

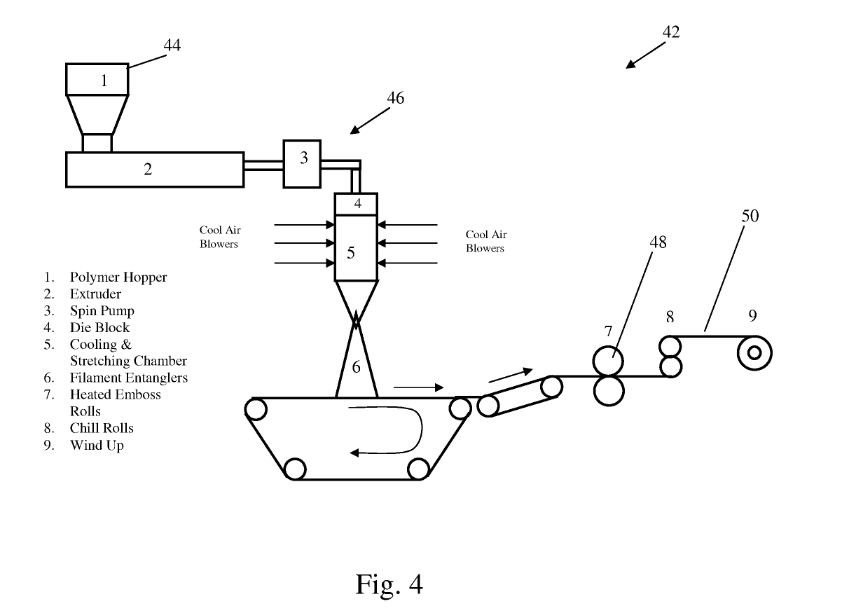

Referring now to FIG. 4, there is schematically illustrated a spunbonding process, illustrated generally at 42, suitable for producing the nonwoven web material 16. However, any fibrous web utilizing bi-component fibers with different melt temperatures should work. In the illustrated spunbonding process 42, chemical components 44 of a spunbonded web 50 are introduced into a melt fiber spinning operation, indicated generally at 46, which creates the bicomponent fibers. The melt fiber spinning operation 46 also spins randomly oriented, essentially continuous fibers into a web. The melt fiber spinning operation 46 provides the web with fiber to fiber bonding at crossover points. The illustrated spunbonding process 42 includes a heat embossing or spot bonding process 48. The heat embossing process 48 creates additional melt points and provides the spunbonded web with additional strength. It should be appreciated that varying the patterns, temperatures and pressures of the embossing process 48 may alter the final properties of the spunbonded web 50. The spunbonded web 50 is suitable for use as the nonwoven web material 16 in the web treatment process 10.

It should be appreciated that fiber deniers may also be adjusted to enhance selected strength and stiffness properties of the final spunbonded web 50. Also, fiber chemistries may be selected to reduce static electricity on the spunbonded web 50, and to facilitate electrolytic cleaning of the spunbonded web 50. The selection of properties of the chemical components 44 fed into the process can alter the properties of the spunbonded web 50.

It should be appreciated that other processes, such as dry and wet spinning spunbonded web, can be used to create a nonwoven web material 16 suitable for the web treatment process. For example, non-melt spinning fibrous web forming processes such as carding can be used to create a suitable web. It should be appreciated that when using non-melt spinning fibrous web forming processes, fiber deniers may be altered, as well as fiber lengths.

Referring back to FIG. 1, in the illustrated web treatment process 10, the illustrated inert film 18 used is a polyester film with a silicon release material, such as a silicon release agent treated Mylar. Mylar is the trademark for a polyester film sold by the E. I. Du Pont de Nemours and Company Corporation. The illustrated inert film 18 has a thickness in the range from 1 to 5 thousandths of an inch. It should be appreciated that some other thickness or some other material could be used for the inert film 18. For example, the inert film 18 could be nylon.

Virtually any film which has a melting temperature higher than the lower melting temperature of the nonwoven web material 16 may be used as the inert film 18. Mylar and nylon are but two such examples of materials which are suitable for use. The release agent treated Mylar used for the illustrated inert film 18 provides a suitable glass transition temperature and melt temperature, and is also chemically inert within the illustrated process. The illustrated inert film 18 also has overall strength that allows it to be reclaimed from the process and reused. The Mylar films have advantageous properties in that they will lightly adhere to the melted component of the bicomponent fibers in the heated compaction nip 26, but if cooled rapidly following the light adhesion, the adhesion is easily reversed by just pulling the Mylar web away. This allows it to be rewound and reused, resulting in significant cost and environmental savings. Another benefit of using Mylar is that even if the Mylar film takes on a little bit of the surface roughness of the fibrous web in the heated adhesion process, or evidences some creasing due to stresses imparted in the heated compaction nip 26, the Mylar can still be reused in the process to transfer a smooth finished surface 32 to the finished web 30.

The illustrated pre-heater 24 temperature is preferably typically within the range from about 150° F. to about 400° F. The use of the pre-heater 24 in the illustrated web treatment process 10 allows for more rapid ply adhesion in the heated compaction nip 26. However, the use of the pre-heater 24 is not necessary, and the same effects could be achieved by longer dwell times within the heated compaction nip 26, for example.

The illustrated heated compaction nip 26 preferably has a pressure in the range from about 25 to about 150 psi. Further, one or both of the rolls 52 and 54 in the heated compaction nip 26 is preferably heated to a temperature in the range from about 250° F. to about 375° F. The most suitable temperatures and pressures used in the heated compaction nip 26 of the web treatment process may vary depending on the composition of the nonwoven web material 16, as well as the desired properties of the finished web 30. It should be appreciated that suitable temperatures and pressures may be determined empirically. Suitable temperatures and pressures vary depending upon the chemistry of the bicomponent fibers and the overall basis weight (including the number of plies) of the nonwovens web.

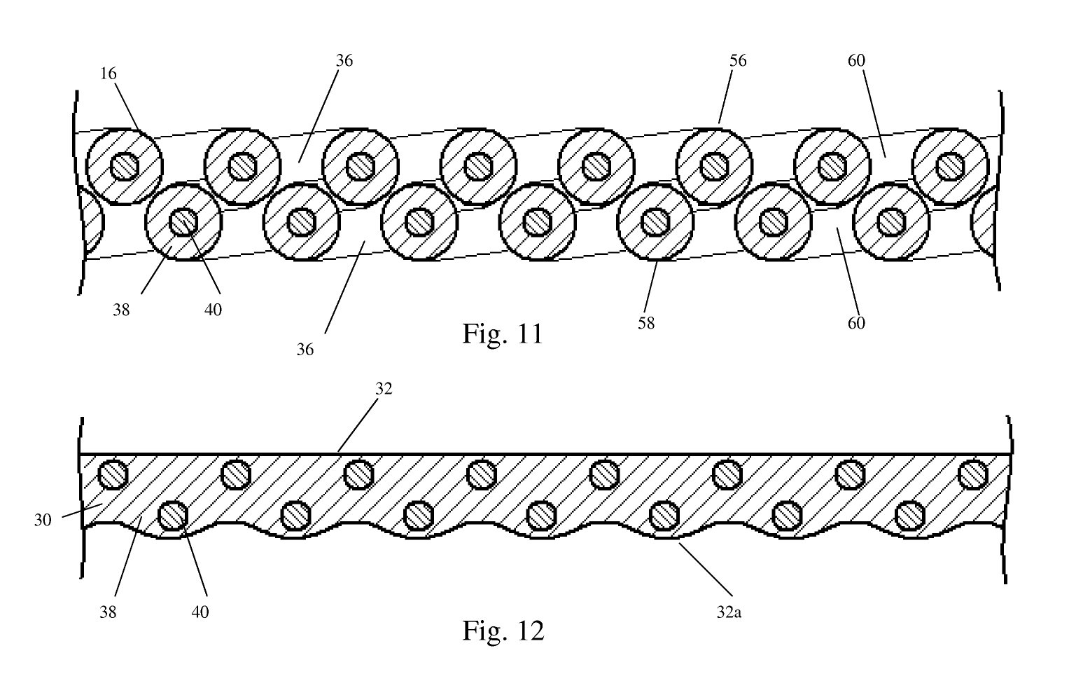

Referring to FIG. 11, a cross sectional view of a portion of the nonwoven web material 16 is shown. As can be seen, the nonwoven web material 16 is comprised of overlapping bicomponent fibers 36. It should be appreciated that while the illustrated nonwoven web material 16 is shown as having the bicomponent fibers 36 distributed in a recurring pattern, this is not necessary, and the fibers in the nonwoven web material 16 may have a random distribution. As can be seen, the nonwoven web material 16 includes a pretreated first face 56 and a pretreated second face 58. The pretreated first face 56 and the pretreated second face 58 of the nonwoven web material 16 have coefficients of friction of approximately 0.50. The pretreated first face 56 and the pretreated second face 58 may have a different coefficient of friction, depending on the material the nonwoven web material 16 is made of, the size of the bicomponent fibers 36, the way the nonwoven web material 16 is manufactured, and other factors. The nonwoven web material 16 also includes openings 60 in the pretreated first face 56 and the pretreated second face 58. The openings 60 are spaces between the bicomponent fibers 36, and may pass through the full thickness of the nonwoven web material 16.

Referring to FIG. 12, a cross sectional view of a portion of the finished web 30 is shown. The web treatment process 10 creates an ultra-smooth finished surface 32 on one face of the finished web 30. The finished surface 32 has a coefficient of friction of 0.30. The finished web 30 also has a second finished face 32a that was not in contact with the inert film during the web treatment process 10. The second finished face 32a does not have the ultra-smooth finished surface, and has a coefficient of friction of 0.34. The finished surface 32 preferably provides a degree of liquid water repellency while allowing water vapor transmission.

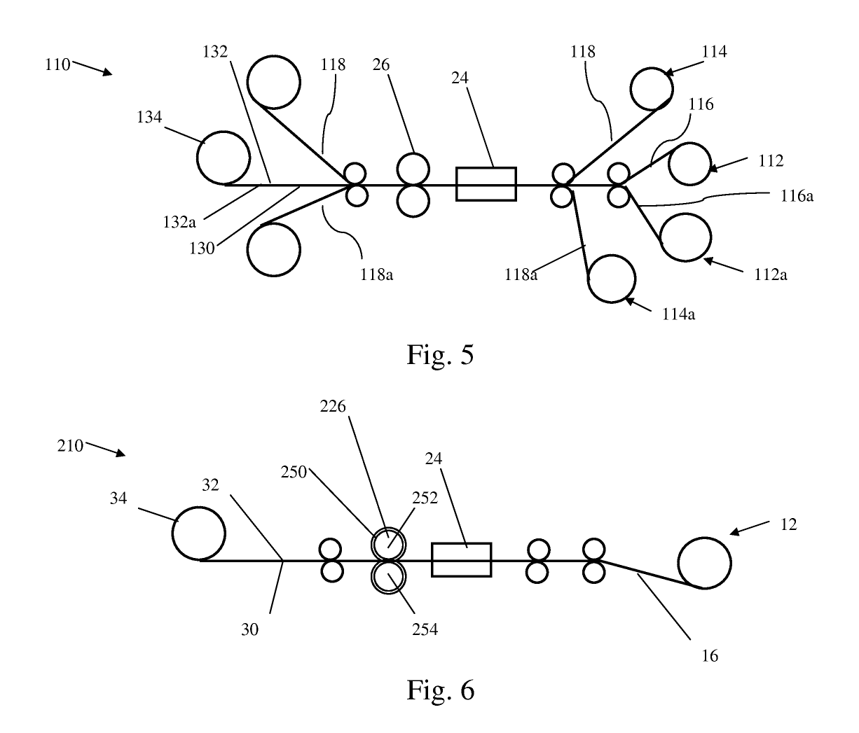

Referring now to FIG. 5, there is schematically illustrated a first alternative web treatment process, indicated generally at 110. In the first alternative web treatment process 110, a first fiber roll 112, a second fiber roll 112a, a first inert roll 114, and a second inert roll 114a are fed into the alternative web treatment process 110. The four rolls are a first fiber web material 116, a second fiber web material 116a, a first inert film 118, and a second inert film 118a, respectively. Materials suitable for use as the fiber web material 16 in the web treatment process 10 are also suitable for use as the first and second fiber web materials 116 and 116a. The first and second fiber web materials 116 and 116a can be the same material as each other, or they can be different materials. Materials suitable for use as the inert film 18 the web treatment process 10 are also suitable for use as the first and second inert films 118 and 118a. The first and second inert films 118 and 118a can be the same material as each other, or they can be different materials.

The first alternative web treatment process 110 produces a finished web 130 with a first finished surface 132 and a second finished surface 132a. The finished web 130 is rewound on a finished fiber roll 134. It should be appreciated that the alternative web treatment process 110 could be operated with only the one fiber web material 116 and the two inert films 118 and 118a, rather than the two fiber web materials 116 and 116a illustrated.

The web treatment process 10 in FIG. 1 illustrates the use of a single fiber web material 16, and the first alternative web treatment process 110 in FIG. 5 illustrates the use of two fiber web materials 116 and 116a. It should be appreciated that more than two fiber web materials can be used with the web treatment processes 10 and 110. The main reason for using more webs is to conveniently increase the basis weight. Increasing the basis weight will help increase the strength, decrease the overall porosity, and decrease the overall drape or flexibility of the finished web. The optimization of these properties depends upon the final product application. Depending upon the number of plies, it is also possible to alter the fiber chemistries of the inner plies so as to obtain an even further variety of properties for the finished web. For example, the outer plies might be more hydrophobic than the inner layers, resulting in a trapping of moisture vapor as it penetrates the web. As another example, the chemistry of the plies may be altered so as to produce what is known in the industry as a one-way-valve for vapor transmission. Varying these properties has inestimable value for selected usage applications of the finished web.

Referring now to FIG. 6, there is illustrated a second alternative web treatment process, indicated generally at 210. The second alternative web treatment process 210 is similar to the web treatment process 10. However, the second alternative web treatment process 210 does not use an inert film 18 married to the nonwoven web material 16. Rather, the second alternative web treatment process 210 includes a covering 250 on the rollers 252 and 254 of a heated compaction nip 226. The covering 250 is chosen to exhibit similar surface characteristics to the inert film 18 used in web treatment process 10. In the illustrated second alternative web treatment process 210, both rollers 252 and 254 of the heated compaction nip 226 include the covering 250. It should be appreciated that each roller 252 and 254 could have a different covering, or only one roller could have the covering.

The web treatment processes 10, 110, and 210 allow the properties of the respective finished webs 30, 130, and 230 to be altered to make the finished web suitable for a wide variety of uses. For example, finished webs 30, 130, and 230 may be used to create a product suitable for use in the food and beverage can-stacking industry. Such a product would need to have high strength, low flex, ultra-smooth surfaces on both sides of the web, vibration dampening properties, relatively high surface slip release, liquid water impermeability, water vapor permeability, no surface fiber protrusions or raw edges, the ability to be electrolytically cleaned, and reusability. In order to create a product having these properties, both sides of the fiber web are treated with an inert film. This product can be made using either a very heavy basis weight single-ply nonwoven, or multiple plies of lighter weight nonwovens.

When creating a product suitable for use as a house wrap, desired characteristics of the finished webs 30, 130, and 230 may include high strength, high flex, liquid water impermeability, and water vapor permeability. Properties of the product, such as the slip characteristics, the vibration dampening characteristics, or the reusability are not as important. Also, surface fiber protrusions or raw edges would be acceptable on this product. Consequently, a lighter weight nonwoven web can be used in order to bring about the desired flex.

When creating a product suitable for mailing envelope construction, desirable characteristics of the finished webs 30, 130, and 230 may be high strength, a lesser degree of liquid water impermeability, and some degree of flex. Consequently, a lighter weight nonwoven web would be used, along with Mylar film on only one side of the web processing.

The finished webs 30, 130, and 230 produced by the described web treatment processes 10, 110, and 210 consist of a conventionally formed fibrous nonwoven web utilizing specifically selected bicomponent fibers for the furnish, which is then treated with a subsequent unique and novel process to render one or both of the fibrous surfaces of the web into an ultra-smooth and nearly film-like surface, not readily achievable with any other known fibrous nonwoven treatment process. Two benefits of this process are that the surfaces of the finished webs 30, 130, and 230 are ultra-smooth and film-like in appearance and texture (without actually becoming a film), and that the alteration of the surface creates a unique and novel way to develop varying degrees of useful porosity (or lack thereof).

The finished web 30, 130, and 230 thus produced, with its ultra-smooth finish in combination with other attendant properties, such as porosity, liquid water impermeability, good water vapor transmission rates, overall strength, drape/flexibility, static release, surface friction, reusability, and ability to be electrolytically cleaned, is a superior product for use in can stacking slip sheets within the food/beverage industry, as a house wrap in the building trade, and as a high-strength medium for mailing envelopes, just to name a few applications.

The principle and mode of operation of this invention have been explained and illustrated in its preferred embodiments. However, it must be understood that this invention may be practiced otherwise than as specifically explained and illustrated without departing from its spirit or scope.

What is claimed is:

1. A method of producing a sheet, the method comprising:
heating a bicomposite sheet to a temperature sufficient to melt one of the materials comprising the bicomposite sheet with the bicomposite sheet adjacent to an inert film.

2. The method of producing a sheet of claim 1, further comprising:
compressing the bicomposite sheet and the inert film together while the bicomposite sheet is at the temperature sufficient to melt one of the materials comprising the bicomposite sheet.

3. The method of producing a sheet of claim 2, further comprising
compressing the bicomposite sheet and the inert film together with a heated compaction nip.

4. The method of producing a sheet of claim 3, further comprising:
placing the bicomposite sheet adjacent to and in contact with the inert film to create a laminate sheet and heating the laminate sheet to the temperature sufficient to melt one of the materials comprising the bicomposite sheet.

5. The method of producing a sheet of claim 4, wherein the heated compaction nip applies a pressure in a range from 25 pounds per square inch to 150 pounds per square inch.

6. The method of producing a sheet of claim 5, wherein the temperature sufficient to melt one of the materials comprising the bicomposite sheet is within a range of 250° F. to 375° F.

7. The method of producing a sheet of claim 6, wherein the bicomposite sheet is comprised of polyester and polypropylene and the inert film is a polyester film with a silicon release material.

8. The method of producing a sheet of claim 3, wherein the inert film is attached to a roller of a heated compaction nip.

9. The method of producing a sheet of claim 2, wherein the bicomposite sheet and the inert film are compressed to a pressure in a range from 25 pounds per square inch to 150 pounds per square inch.

10. The method of producing a sheet of claim 1, wherein the heating of the bicomposite sheet is to a temperature that is not sufficient to melt another one of the materials comprising the bicomposite sheet.

11. The method of producing a sheet of claim 10, further comprising:
placing the bicomposite sheet adjacent to and in contact with the inert film to create a laminate sheet and heating the laminate sheet to the temperature sufficient to melt one of the materials comprising the bicomposite sheet.

12. A sheet comprising:
a fiber material that is heated to a temperature sufficient to melt a portion the fiber material and is placed in contact with an inert film so that at least one surface of the fiber material is able to take on the characteristics of the inert film.

13. The sheet of claim 12, wherein the fiber material is a bicomposite fiber material.

14. The sheet of claim 13, wherein the sheet has a coefficient of friction less than or equal to 0.30.

15. The sheet of claim 14, wherein the bicomposite fiber material has a coefficient of friction of 0.50.
